(19) United States
(12) Patent Application Publication
(10) Pub. No.: US 2011/0260689 A1
(43) Pub. Date: Oct. 27, 2011

(54) INFORMATION PROCESSING APPARATUS AND CHARGE AND DISCHARGE CONTROL METHOD

(75) Inventor: Akio KANO, Ome-shi (JP)

(73) Assignee: KABUSHIKI KAISHA TOSHIBA, Tokyo (JP)

(21) Appl. No.: 13/092,844

(22) Filed: Apr. 22, 2011

(30) Foreign Application Priority Data
Apr. 22, 2010 (JP) 2010-098960

(51) Int. Cl. H02J 7/00

(52) U.S. Cl. 320/128

(57) ABSTRACT

According to one embodiment, an information processing apparatus is configured to receive powers from a first battery and a second battery, a charge-discharge cycle life of the second battery being longer than the first battery. The information processing apparatus comprises a power-supply circuit and a charging module. The power-supply circuit is configured to discharge the second battery more preferentially than the first battery in order to supply power to the components in the information processing apparatus, when the first battery and the second battery are in a dischargeable state. The charging module is configured to charge the second battery more preferentially than the first battery when the first battery and second battery are not in a fully-charged state.

### CROSS-REFERENCE TO RELATED APPLICATIONS

This application is based upon and claims the benefit of priority from Japanese Patent Application No. 2010-098960, filed Apr. 22, 2010; the entire contents of which are incorporated herein by reference.

### FIELD

Embodiments described herein relate generally to an information processing apparatus such as a battery-drivable computer, and a charge and discharge control method applied to the apparatus.

### BACKGROUND

In recent years, various portable personal computers of a notebook-type or laptop-type are developed. Most of such personal computers are configured to be battery-drivable. As a battery to be applied to a personal computer, for example, a lithium-ion battery is known. Recently, an increase in capacity of the lithium-ion battery has been advanced, whereby it is possible to drive a personal computer by a battery for a long time. Further, a system in which battery packs of a plurality of types different from each other in battery characteristic are incorporated is also known.

On the other hand, owing to the more rugged/higher-reliability design of personal computers, the quality (life) of personal computers has also been significantly improved. Accordingly, for a personal computer, not only enhancement of the capacity of the battery, but also achievement of a long life of the battery is required.

In general, it is known that the performance (for example, the chargeable capacity) of a battery is gradually lowered by repetition of charge and discharge. For this reason, as an index indicating the life of the battery, a charge-discharge cycle life (or simply called a cycle life) is used. The charge-discharge cycle life of the battery can be defined as, for example, the number of charge-discharge cycles at the time at which the chargeable capacity of the battery lowers to a predetermined ratio of the original capacity of the battery.

Incidentally, recently, in order to prolong the life of a battery, development of a new type of battery which is less deteriorated in performance by charge and discharge has been started. A battery designed with the intention of achieving a long life may have a long life equivalent to those of various electronic components in the computer. Accordingly, the battery aiming at achievement of a long life enables system design premised on no battery replacement.

However, in general, the battery capacity and battery life are in a trade-off relationship. It is usual that the capacity per unit volume of a battery designed with the intention of achieving a long life is less than that of a battery designed with the intention of achieving high capacity. As a result of this, if a battery designed with the intention of achieving a long life is simply applied to a computer, the battery drive time of the computer may become short.

Accordingly, realization of a new technique which enables the battery life to be prolonged without sacrificing the battery drive time is demanded.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an information processing apparatus according to an embodiment.

FIG. 2 is an exemplary view for explaining an example of characteristics of each of two batteries to be attached to the information processing apparatus according to the embodiment.

FIG. 3 is an exemplary block diagram illustrating the system configuration of the information processing apparatus according to the embodiment.

FIG. 4 is an exemplary circuit diagram illustrating the configuration of a power-supply system in the information processing apparatus according to the embodiment.

FIG. 5 is an exemplary flowchart illustrating a procedure of battery connection check processing executed by the information processing apparatus according to the embodiment.

FIG. 6 is an exemplary flowchart illustrating a procedure of charge start processing executed by the information processing apparatus according to the embodiment.

FIG. 7 is an exemplary view for explaining an operation of charging the two batteries attached to the information processing apparatus according to the embodiment.

FIG. 8 is an exemplary view for explaining diode-OR connection applied to the two batteries attached to the information processing apparatus according to the embodiment.

FIG. 9 is an exemplary view for explaining an operation of discharging the two batteries attached to the information processing apparatus according to the embodiment.

FIG. 10 is an exemplary circuit diagram illustrating a switch circuit configured to carry out switching between the two batteries attached to the information processing apparatus according to the embodiment.

FIG. 11 is an exemplary view illustrating a booster circuit to be connected to an output of one of the two batteries attached to the information processing apparatus according to the embodiment.

FIG. 12 is an exemplary view illustrating an example of a relationship between an example of use of the information processing apparatus according to the embodiment, and charge and discharge of each of the two batteries.

FIG. 13 is an exemplary flowchart illustrating a procedure of battery-switching processing executed by the information processing apparatus according to the embodiment at the discharge start time.

FIG. 14 is an exemplary flowchart illustrating a procedure of battery-switching processing executed by the information processing apparatus according to the embodiment when one of the batteries enters a low-battery state.

### DETAILED DESCRIPTION

Various embodiments will be described hereinafter with reference to the accompanying drawings.

In general, according to one embodiment, an information processing apparatus is configured to receive powers from a first battery and a second battery, a charge-discharge cycle life of the second battery being longer than the first battery. The information processing apparatus comprises a power-supply circuit and a charging module. The power-supply circuit is configured to discharge the second battery more preferentially than the first battery in order to supply power to the components in the information processing apparatus, when the first battery and the second battery are in a dischargeable state. The charging module is configured to charge the second battery more preferentially than the first battery when the first battery and second battery are not in a fully-charged state.

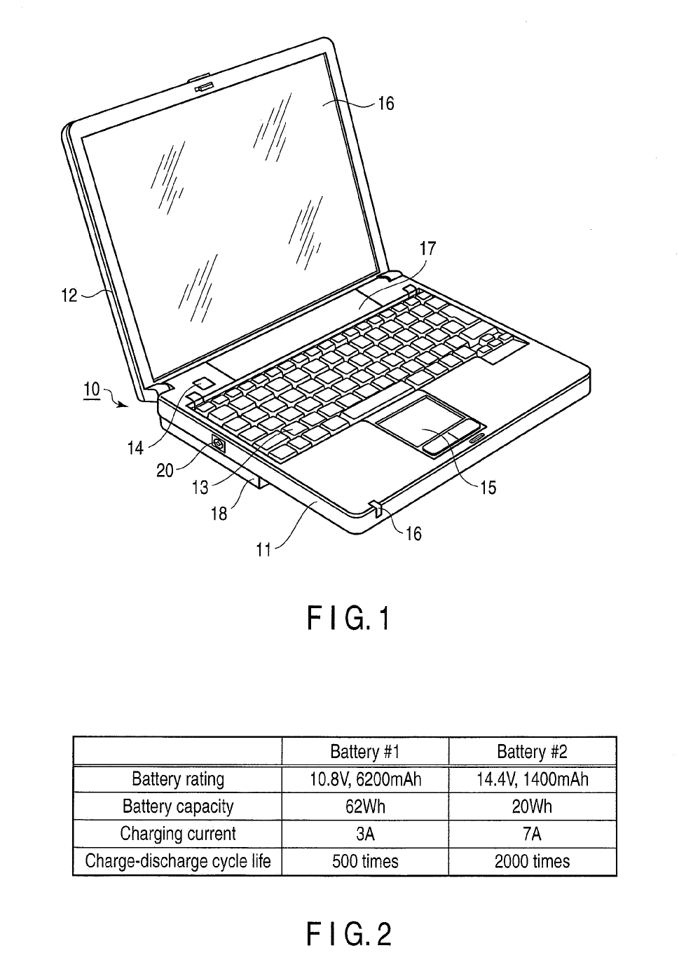

First, the configuration of the information processing apparatus according to an embodiment will be described below with reference to FIG. 1. This information processing apparatus is realized as, for example, a portable notebook-sized personal computer 10 which can be powered by a battery. FIG. 1 is a perspective view of the computer 10 viewed from the front side in a state where a display unit thereof is opened. This computer 10 is configured to receive power (electric power) from a first battery 17 and second battery 18. The first battery 17 and second battery 18 have characteristics different from each other.

The first battery 17 may be constituted of an ordinary lithium-ion battery or the like aiming at achievement of high capacity (high-capacity battery). Normally, when a battery is subjected to fast charge, the charge-discharge cycle life (also referred to simply as a cycle life) of the battery is adversely affected. Accordingly, in a lithium-ion battery aiming at achievement of high capacity, in order to prevent the charge-discharge cycle life thereof from becoming short, the charging current tends to be held down to a small value.

On the other hand, as the second battery 18, for example, a battery a charge-discharge cycle life of which is longer than the first battery 17, i.e., a battery less subject to deterioration caused by charge and discharge, e.g., a battery less subject to lowering of the chargeable capacity is used. The second battery 18 is less subject to deterioration in performance caused by charge and discharge, and hence the second battery 18 can be subjected to fast charge using a large charging current. Accordingly, it can be said that the second battery 18 is a battery capable of fast charge, and is a long-life battery. As described previously, the battery capacity and charge-discharge cycle life of the battery are in a trade-off relationship, and hence although the second battery 18 is lower than the first battery 17 in capacity, the battery 18 is more resistant to fast charge than the first battery 17, and the charge-discharge cycle life thereof is longer than that of the first battery 17.

As a battery the charge-discharge cycle of which is long, for example, the SCiB™ rechargeable battery or the like developed by TOSHIBA CORPORATION can be mentioned.

In this computer 10, in order to supply power to components in the computer 10, the second battery 18 is discharged more preferentially than the first battery 17. More specifically, when each of the first battery 17 and second battery 18 is in a dischargeable state, in order to supply power to the components in the computer 10, the power-supply circuit in the computer 10 discharges the second battery 18 more preferentially than the first battery 17. That is, the second battery 18 functions as a power source configured to supply power to the components in the computer 10. When the residual capacity of the second battery 18 has lowered to a value less than the threshold, i.e., when the second battery 18 has entered a low-battery state or a state close to the low-battery state, the battery to be discharged, i.e., the power source is automatically switched from the second battery 18 to the first battery 17.

The power-power output terminal of the first battery 17 may be connected to the power-power output terminal of the second battery 18 by wired-OR connection. In this case, the output voltage of the second battery 18 may be set in such a manner that the output voltage of the second battery 18 becomes higher than the output voltage of the first battery 17. As a result of this, it becomes possible to discharge the second battery 18 more preferentially than the first battery 17 by means of the wired-OR connection. The output voltage of the second battery 18 can be adjusted by changing, for example, the number of battery cells connected in series in the second battery 18, i.e., the number of cells to be connected in series.

Furthermore, a charging circuit in the computer 10 charges the second battery 18 more preferentially than the first battery 17. More specifically, when the first battery 17 and second battery 18 are not in the fully-charged state, the computer 10 charges the second battery 18 more preferentially than the first battery 17 by using power supplied from an external power-supply.

As described above, in this embodiment, charge and discharge is applied to the second battery 18 more preferentially than the first battery 17. As a result of this, in the computer 10, the frequency in the application of charge and discharge to the first battery 17 can be reduced, whereby the time at which deterioration of the chargeable capacity of the first battery 17 starts can be delayed. Accordingly, the chargeable capacity of the first battery 17 can be maintained at a value close to the original capacity for a long time. The charge-discharge cycle life of the second battery 18 is long. Even if the use frequency (frequency in charge and discharge) of the second battery 18 is high, the degree of deterioration in the chargeable capacity of the second battery 18 is very small. Accordingly, the configuration of this embodiment in which charge and discharge is applied to the second battery 18 more preferentially than the first battery 17 makes it possible to maintain a sufficiently long battery drive time for a long time.

This computer 10 comprises a computer main body 11 and display unit 12. A display device constituted of a Liquid Crystal Display (LCD) 16 is incorporated in the display unit 12.

The display unit 12 is supported on the computer main body 11. The display unit 12 is attached to the main body 11 rotatable between an opened position at which the top surface of the computer main body 11 is exposed, and closed position at which the top surface of the computer main body 11 is covered with the display unit 12. The computer main body includes a thin box-like housing and, on the top surface thereof, a keyboard 13, power switch 14 used to turn on/off the power of the computer 10, and touch pad 15 are arranged.

Further, the computer main body 11 comprises a power connector 20. The power connector 20 is provided on the side surface of the computer main body 11, for example, the left side surface thereof. An external power-supply is detachably connected to the power connector 20. As the external power-supply, an AC adapter can be used. The AC adapter is a power-supply configured to convert the commercial power (AC power) into DC power.

The power connector 20 is constituted of a jack to which a power plug derived from the external power-supply can be detachably connected. The first battery 17 is detachably attached to the computer main body 11 at, for example, a rear-end part thereof. On the other hand, the second battery 18 is detachably attached to the computer main body 11 at, for example, an underside part thereof. The first battery 17 may be a battery basically incorporated in the computer 10, and second battery 18 may be an optional battery which can be attached to the computer 10 as the need arises.

The computer 10 is driven by the power from the external power-supply, power from the first battery 17 or power from the second battery 18. When the external power-supply is connected to the power connector 20 of the computer 10, the computer 10 is driven by the power from the external power-supply. Further, the power from the external power-supply is also used to charge the first battery 17 or the second battery 18. Charging of the first battery 17 or the second battery 18 may be carried out not only while the computer 10 is powered on, but also while the computer 10 is powered off. While the external power-supply is not connected to the power connector 20 of the computer 10, the computer 10 is driven by the power from the first battery 17 or the power from the second battery 18.

Further, the computer main body 11 is provided with an indicator 16 configured to notify various power-supply statuses such as presence/absence of the external power-supply and the like. The indicator 16 is provided at a position, for example, in front of the computer main body 11. The indicator 16 can be constituted of an LED.

FIG. 2 shows an example of the characteristics of each of the first battery 17 and second battery 18. The first battery 17 may be, for example, a high-capacity lithium-ion battery. Example characteristics of the first battery 17 are as follows.

Rated voltage: for example, 10.8 [V]

Rated current: for example, 6200 [mAh]

Capacity: for example, 62 [Wh](=10.8 [V]×6200 [mAh])

Charging current: 3 [A]

Charge-discharge cycle life: for example, 500 times

When full capacity charging of the first battery 17 has been executed 500 times, the chargeable capacity of the first battery 17 is reduced to, for example, 90 [%] of the original capacity thereof.

On the other hand, the second battery 18 may be, for example, an SCiB battery. Although the SCiB battery is a kind of lithium-ion battery, inactive oxide is employed as a material of the negative electrode thereof in place of carbon. As a result of this, the SCiB battery can acquire high resistance against charge and discharge, and has a feature of long life (that is, the charge-discharge cycle life is long). Furthermore, the SCiB battery has a fast-charge capability higher than an ordinary lithium-ion battery, and a charging current larger than that of an ordinary lithium-ion battery can be employed in charging of the SCiB battery.

Example characteristics of the second battery 18 are as follows.

Rated voltage: for example, 14.4 [V]

Rated current: for example, 1400 [mAh]

Capacity: for example, 20 [Wh] (=14.4 [V]×1400 [mAh])

Charging current: for example, 7 [A]

Charge-discharge cycle life: for example, 2000 times

When full capacity charging of the second battery 18 has been carried out 2000 times, the chargeable capacity of the second battery is reduced to, for example, 90 [%] of the original capacity thereof.

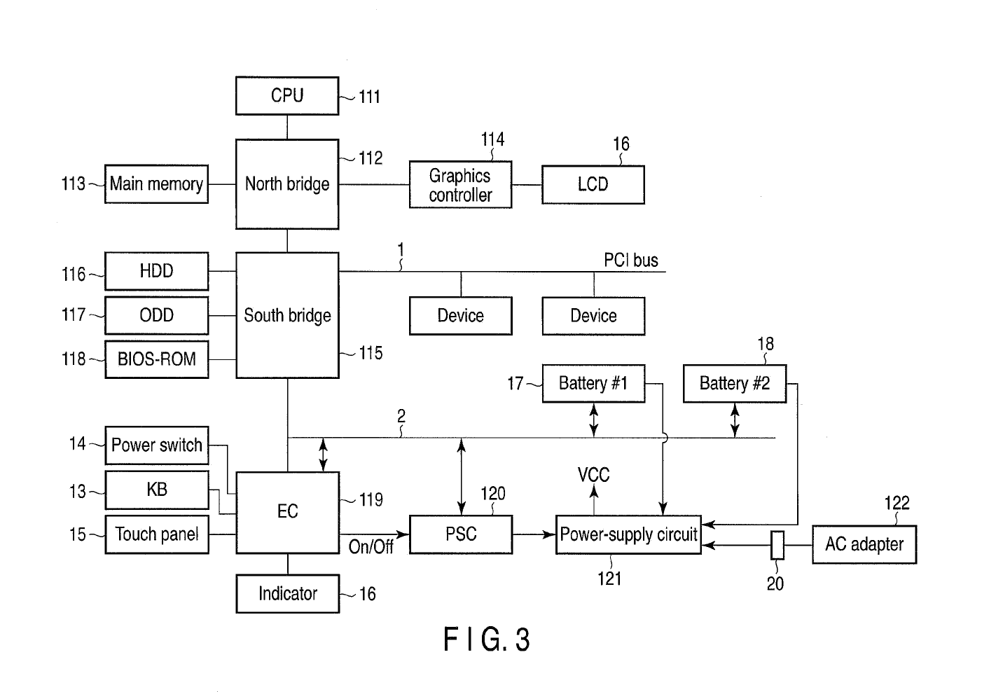

FIG. 3 shows the system configuration of the computer 10. The computer 10 comprises a CPU 111, north bridge 112, main memory 113, graphics controller 114, south bridge 115, hard disk drive (HDD) 116, optical disk drive (ODD) 117, BIOS-ROM 118, embedded controller (EC) 119, power-supply controller (PSC) 120, power-supply circuit 121, AC adapter 122, and the like. The AC adapter 122 is used as the above-mentioned external power-supply.

The CPU 111 is a processor configured to control operations of various components of the computer 10. The CPU 111 executes various software items loaded from the HDD 116 into the main memory 113, for example, an operating system (OS) and various application programs. Further, the CPU 111 also executes a Basic Input Output System (BIOS) stored in the BIOS-ROM 118 which is a nonvolatile memory. The BIOS is a system program for hardware control.

The north bridge 112 is a bridge device configured to connect a local bus of the CPU 111 and the south bridge 115 to each other. Further, the north bridge 112 also has a function of executing communication with the graphics controller 114. Furthermore, a memory controller configured to control the main memory 113 is incorporated in the north bridge 112. The graphics controller 114 is a display controller configured to control the LCD 16 to be used as a display monitor of the computer 10.

The south bridge 115 is connected to a PCI bus 1, and executes communication with devices on the PCI bus 1. Further, an Integrated Drive Electronics (IDE) or Serial ATA controller configured to control the hard disk drive (HDD) 116 and optical disk drive (ODD) 117 are incorporated in the south bridge 115.

The EC 119, power-supply controller (PSC) 120, and batteries 17, 18 are connected to each other through a serial bus 2 such as an I²C bus. The embedded controller (EC) 119 is a power management controller configured to execute power control of the computer 10, and is realized as, for example, a one-chip microcomputer in which a keyboard controller configured to control the keyboard (KB) 13, touch pad 15, and the like is incorporated. The EC 119 has a function of turning on/off the power of the computer 10 in accordance with an operation of the power switch 14 carried out by the user. Control of turning on/off of the power of the computer 10 is executed by a cooperative operation of the EC 119 and power-supply controller (PSC) 120. Upon receipt of an ON signal transmitted from the EC 119, the power-supply controller (PSC) 120 controls the power-supply circuit 121 to turn on the power of the computer 10. Further, upon receipt of an OFF signal transmitted from the EC 119, the power-supply controller (PSC) 120 controls the power-supply circuit 121 to turn off the power of the computer 10. Even while the computer 10 is in the off-state, the EC 119, power-supply controller (PSC) 120, and power-supply circuit 121 operate by the power from the battery 17 or 18 or the AC adapter 122.

The power-supply circuit 121 produces power (operating power) to be supplied to the various components by using the power from one of the batteries 17 and 18 attached to the computer main body 11 or power from the AC adapter 122 to be connected to the computer main body 11 as the external power-supply. If the AC adapter 122 is connected to the computer main body 11, the power-supply circuit 121 produces the operating power to be supplied to the components by using the power from the AC adapter 122, and charges the battery 17 or 18 by turning on a charging circuit.

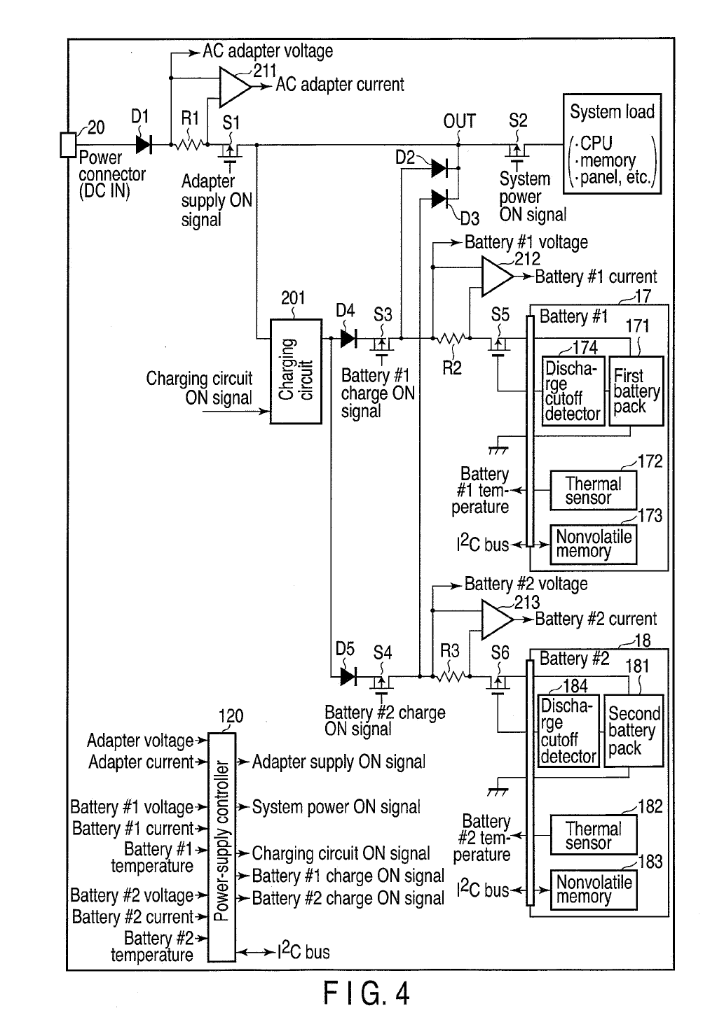

Next, a configuration example of the power-supply system in the computer 10 will be described below with reference to FIG. 4.

The power-supply system of FIG. 4 includes diodes D1, D2, D3, D4, and D5, AC adapter current detector 211, battery current detectors 212 and 213, switches S1, S2, S3, S4, S5, and S6, charging circuit 201, and the like. The diodes D1, D2, D3, D4, and D5, AC adapter current detector 211, battery current detectors 212 and 213, and switches S1, S2, S3, S4, S5, and S6 function as the above-mentioned power-supply circuit 121.

In this power-supply system, the diode D1 is connected between the power connector (DC IN) 20 configured to connect the AC adapter 122, and a power output terminal OUT configured to supply power to the system load. The diode D2 is connected between a power-supply terminal of the first battery 17, and power output terminal OUT. Furthermore, the diode D3 is connected between the power-supply terminal of the second battery 18, and power output terminal OUT. In other words, the power connector (DC IN) 20 is connected to the power output terminal OUT of the power-supply circuit 121, which is configured to supply power to the system load (CPU, memory, LCD panel, and the like), through the diode D1. The power-supply terminal of the first battery 17 is connected to the power output terminal OUT of the power-supply circuit 121 through the diode D2. Furthermore, the power-supply terminal of the second battery 18 is connected to the power output terminal OUT of the power-supply circuit 121 through the diode D3.

It should be noted that a DC to DC converter may be arranged between the power output terminal OUT and system load.

The charging circuit 201 is a charger configured to charge the first battery 17 or the second battery 18 by using power from the AC adapter 122 to be input through the power connector (DC IN) 20. An output terminal of the charging circuit 201 is connected to the power-supply terminal of the first battery 17 through the diode D4, and is further connected also to the power-supply terminal of the second battery 18 through the diode D5.

The switch S1 is a switch circuit configured to activate or inactivate a discharge path of the AC adapter 122, and is constituted of, for example, an FET. A resistor R1 is inserted in the discharge path of the AC adapter 122. The adapter current detector 211 detects a current output from the AC adapter 122, i.e., an AC adapter current on the basis of a voltage across the resistor R1. The switch S2 is a switch circuit configured to turn on or turn off the power of the computer 10, and is constituted of, for example, an FET.

The switch S3 is a switch circuit configured to activate or inactivate a charging path used to charge the first battery 17, and is constituted of, for example, an FET. The switch S4 is a switch circuit configured to activate or inactivate a charging path used to charge the second battery 18, and is constituted of, for example, an FET.

In addition to the above-mentioned diode D2, a resistor R2 is inserted in the discharge path of the first battery 17. The battery current detector 212 detects a discharging current (battery #1 current) of the first battery 17 on the basis of a voltage across the resistor R2. In addition to the above-mentioned diode D3, a resistor R3 is inserted in the discharge path of the second battery 18. The battery current detector 213 detects a discharging current (battery #2 current) of the second battery 18 on the basis of a voltage across the resistor R3.

The first battery 17 comprises a first battery pack (also called an assembled battery) 171, thermal sensor 172, nonvolatile memory 173, and discharge cutoff detector 174. The first battery pack 171 is constituted of several lithium-ion batteries. The thermal sensor 172 detects a temperature (battery #1 temperature) inside the first battery 17. The thermal sensor 172 may include, for example, a thermistor, Analog to Digital converter (A/D converter), and the like. The A/D converter converts the temperature detected by the thermistor from an analog value thereof into a digital value. The nonvolatile memory 173 stores therein battery information indicative of the characteristic and state of the first battery 17. The battery information includes charge-discharge characteristics data of the first battery 17. The charge-discharge characteristics data shows the battery rating of the first battery 17, battery capacity of the first battery 17, charging current of the first battery 17, charge-discharge cycle life of the first battery 17, and the like. The battery information may further include status information indicating the current state of the first battery 17 such as the residual capacity and the like. The discharge cutoff detector 174 detects, in order to prevent over-discharge of the first battery 17, i.e., the first battery pack 171, that the output voltage of the first battery 17, i.e., the output voltage of the first battery pack 171 has lowered to a discharge cutoff voltage. When it is detected that the output voltage of the first battery 17, i.e., the output voltage of the first battery pack 171 has lowered to the discharge cutoff voltage, the discharge cutoff detector 174 turns off the switch S5 inserted in the discharge path of the first battery 17 to stop the discharge of the first battery 17. The switch S5 is constituted of, for example, an FET.

The second battery 18 includes a second battery pack 181, thermal sensor 182, nonvolatile memory 183, and discharge cutoff detector 184. The second battery pack 181 may be constituted of, for example, several SCiB batteries. The thermal sensor 182 detects a temperature (battery #2 temperature) inside the second battery 18. The thermal sensor 182 may include, for example, a thermistor, A/D converter, and the like. The A/D converter converts the temperature detected by the thermistor from an analog value thereof into a digital value. The nonvolatile memory 183 stores therein battery information indicative of the characteristics and state of the second battery 18. The battery information includes charge-discharge characteristics data of the second battery 18. The charge-discharge characteristics data shows the battery rating, battery capacity, charging current, charge-discharge cycle life, and the like of the second battery 18. The battery information may further include status information indicating the current state of the second battery 18 such as the residual capacity and the like. The discharge cutoff detector 184 detects, in order to prevent over-discharge of the second battery 18, i.e., the second battery pack 181, that the output voltage of the second battery 18, i.e., the output voltage of the second battery pack 181 has lowered to a discharge cutoff voltage. When it is detected that the output voltage of the second battery 18, i.e., the output voltage of the second battery pack 181 has lowered to the discharge cutoff voltage, the discharge cutoff detector 184 turns off the switch S6 inserted in the discharge path of the second battery 18 to stop the discharge of the second battery 18. The switch S6 is constituted of, for example, an FET.

The power-supply controller (PSC) 120 is configured to carry out the following operations.

(1) The power-supply controller (PSC) 120 monitors a voltage value (AC adapter voltage) and current value (AC adapter current) of the AC adapter output line. By this monitoring, the power-supply controller 120 detects whether or not the AC adapter 122 is connected to the computer 10.

(2) Upon detecting that the AC adapter 122 is connected to the computer 10, the power-supply controller 120 turns on the switch S1 by an adapter supply ON signal to prepare for supply of power to the system load and charging circuit 201.

(3) The power-supply controller 120 detects that the first battery 17 has been connected to a first battery terminal of the computer 10 on the basis of an A/D conversion value (battery #1 temperature) of the battery temperature of the first battery 17. Furthermore, the power-supply controller 120 monitors each of a voltage, current, and temperature of the first battery 17. When the connection of the first battery 17 is detected, the power-supply controller 120 reads the battery information from the nonvolatile memory 173 in the first battery 17 through the serial bus 2, and recognizes the characteristic of the first battery 17, and current state of the first battery 17 on the basis of the read battery information.

(4) The power-supply controller 120 can control charging of the first battery 17 by means of a charging circuit ON signal and battery #1 charge ON signal.

(5) The power-supply controller 120 also carries out the operations of the above items (3) and (4) with respect to the second battery 18. That is, the power-supply controller 120 detects that the second battery 18 has been connected to a second battery terminal of the computer 10 on the basis of an A/D conversion value (battery #2 temperature) of the battery temperature of the second battery 18. Furthermore, the power-supply controller 120 monitors each of a voltage, current, and temperature of the second battery 18. When the connection of the second battery 18 is detected, the power-supply controller 120 reads the battery information from the nonvolatile memory 183 in the second battery 18 through the serial bus 2, and recognizes the characteristics of the second battery 18, and current state of the second battery 18 on the basis of the read battery information. Furthermore, the power-supply controller 120 can control charging of the second battery 18 by means of a charging circuit ON signal and battery #2 charge ON signal.

(6) In the power-supply system of this embodiment, the AC adapter 122, first battery 17, and second battery 18 are connected to the power output terminal OUT through the diodes D1, D2, and D3. By the diode-OR connection of the AC adapter 122, first battery 17, and second battery 18 described above, it is possible to use one of the AC adapter 122, first battery 17, and second battery 18 having the highest output voltage as a power source for supplying power to the system load.

In this embodiment, the output voltage of, for example, the AC adapter 122 is set at the highest value. The output voltage of the second battery 18 is set higher than the output voltage of the first battery 17. In this case, the priority of the AC adapter 122 is the highest, priority of the second battery 18 is the second highest, and priority of the first battery 17 is the lowest.

The AC adapter 122 is used as the power source more preferentially than the first battery 17 and second battery 18. As a result of this, when the AC adapter 122 is connected to the computer 10, it is possible to supply power to the components in the computer 10 by the power from the AC adapter 122. While the AC adapter 122 operates as the power source, the voltage of the power output terminal OUT is higher than any one of the output voltage of the first battery 17, and output voltage of the second battery 18. Accordingly, the first battery 17 and second battery 18 are not discharged. On the other hand, when the AC adapter 122 is not connected to the computer 10, in order to supply power to the components in the computer 10, the second battery 18 is discharged more preferentially than the first battery 17. When the residual capacity of the second battery 18 gets close to the low-battery state, the output voltage of the second battery 18 is lowered to a voltage lower than or equal to the output voltage of the first battery 17. At this time, the power source is automatically switched from the second battery 18 to the first battery 17.

Next, charge control processing to be carried out by the power-supply controller 120 will be described below.

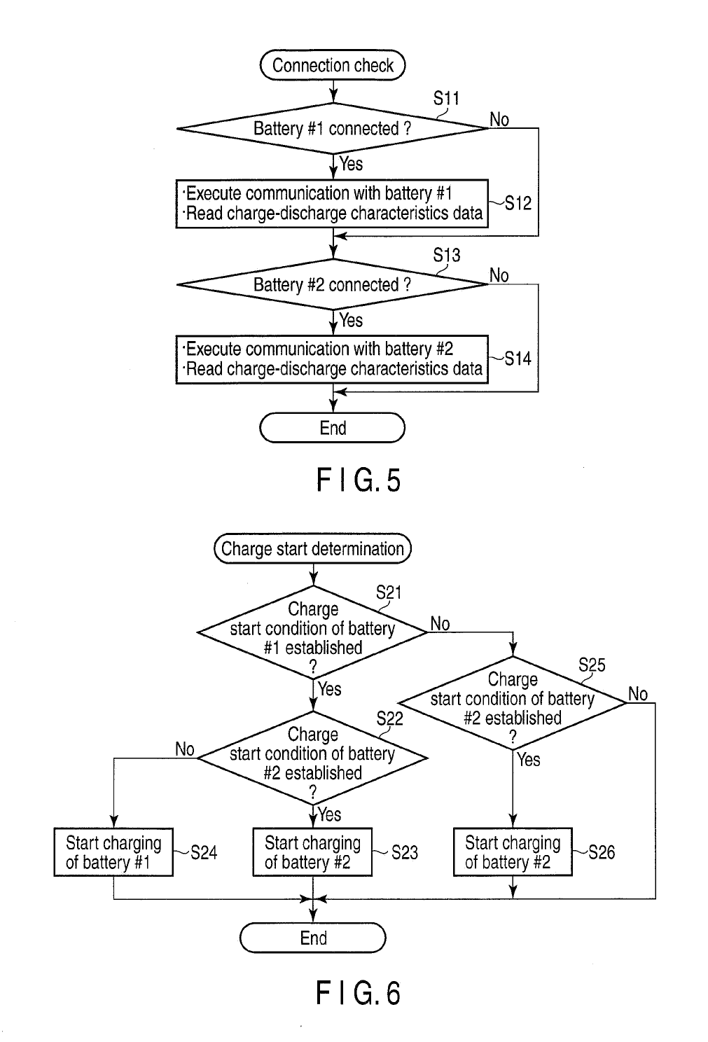

(1) First, the power-supply controller 120 determines whether or not each of the first battery 17 and second battery 18 is attached to the computer 10 in accordance with the flowchart of FIG. 5. In this case, the power-supply controller 120 determines whether or not the first battery 17 is connected to the first battery terminal of the computer 10 (step S11). If the first battery 17 is connected to the first battery terminal of the computer 10, the power-supply controller 120 communicates with the first battery 17 through the serial bus 2, and reads the battery information including the charge-discharge characteristics data from the first battery 17 (step S12). Next, the power-supply controller 120 determines whether or not the second battery 18 is connected to the second battery terminal of the computer 10 (step S13). If the second battery 18 is connected to the second battery terminal of the computer 10, the power-supply controller 120 communicates with the second battery 18 through the serial bus 2, and reads the battery information including the charge-discharge characteristics data from the second battery 18 (step S14).

(2) When the power-supply controller 120 has detected that both the first battery 17 and second battery 18 are connected to the computer 10, the power-supply controller 120 executes the following charge control processing in accordance with the flowchart of FIG. 6.

First, the power-supply controller 120 determines whether or not a charge start condition of the first battery 17 has been established (step S21). The charge start condition of the first battery 17 is, in general, that the first battery 17 is not in the fully-charged state. More specifically, the charge start condition of the first battery 17 is established when three conditions of, for example, (1) the first battery 17 is not in the fully-charged state, (2) the AC adapter is connected to the computer 10, and output voltage of the AC adapter is normal, and (3) the temperature of the first battery 17 is normal, are established. Needless to say, when the two conditions of (1) and (2) have been established, it may be determined that the charge start condition of the first battery 17 has been established.

When the charge start condition of the first battery 17 is established (YES in step S21), the power-supply controller 120 determines whether or not the charge start condition of the second battery 18 has been established (step S22). The charge start condition of the second battery 18 is, in general, that the second battery 18 is not in the fully-charged state. More specifically, the charge start condition of the second battery 18 is established when three conditions of, for example, (1) the second battery 18 is not in the fully-charged state, (2) the AC adapter is connected to the computer 10, and output voltage of the AC adapter is normal, and (3) the temperature of the second battery 18 is normal, are established. Needless to say, when the two conditions of (1) and (2) have been established, it may be determined that the charge start condition of the second battery 18 has been established.

When both the charge start condition of the first battery 17, and charge start condition of the second battery 18 are established (YES in step S22), the power-supply controller 120 starts the charging of the second battery 18 more preferentially than the charging of the first battery 17 (step S23). When only the charge start condition of the first battery 17 is established, and charge start condition of the second battery 18 is not established yet (NO in step S22), the power-supply controller 120 starts the charging of the first battery 17 (step S24).

On the other hand, when the charge start condition of the first battery 17 is not established yet (NO in step S21), the power-supply controller 120 determines whether or not the charge start condition of the second battery 18 is established (step S25). When the charge start condition of the first battery 17 is not established yet, and only the charge start condition of the second battery 18 is established (YES in step S25), the power-supply controller 120 starts the charging of the second battery 18 (step S26).

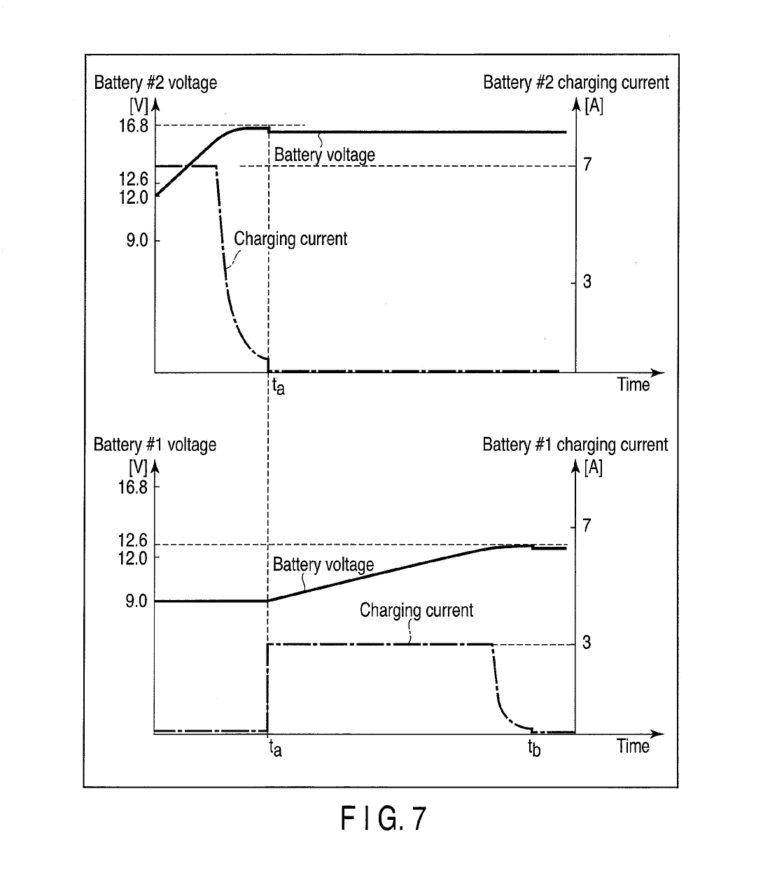

The graph shown on the upper side of FIG. 7 shows the variation characteristics of a charging current and battery voltage of the second battery 18 in the charging period. The axis of ordinate of the graph indicates the output voltage (battery #2 voltage) of the second battery 18, and charging current (battery #2 charging current) of the second battery 18, and axis of abscissa of the graph indicates time. The graph shown on the lower side of FIG. 7 shows the variation characteristics of a charging current and battery voltage of the first battery 17 in the charging period. The axis of ordinate of the graph indicates the output voltage (battery #1 voltage) of the first battery 17, and charging current (battery #1 charging current) of the first battery 17, and axis of abscissa of the graph indicates time.

Here, a case where the AC adapter 122 is connected to the computer 10, and first battery 17 and second battery 18 are not in the fully-charged state is assumed. In this case, first, the second battery 18 is preferentially charged. After the second battery 18 is fully charged, the charging of the first battery 17 is started. More specifically, the following charging operation may be carried out.

(1) The second battery 18 is first subjected to constant-current charge at a charging current of 7 [A].

(2) When the voltage of the second battery 18 has risen to a value close to a certain threshold voltage, the charging of the second battery 18 is switched from, for example, the constant-current charge to constant-voltage charge.

(3) When the second battery 18 has entered the fully-charged state, i.e., when the output voltage of the second battery 18 has risen to an output voltage corresponding to the fully-charged state of the second battery 18 (timing tₐ of FIG. 7), the charging of the second battery 18 is terminated. Further, the battery to be charged is switched from the second battery 18 to the first battery 17.

(4) The first battery 17 is subjected to constant-current charge at a charging current of 3 [A].

(5) When the voltage of the first battery 17 has risen to a value close to a certain threshold voltage, the charging of the first battery 17 is switched from, for example, the constant-current charge to constant-voltage charge.

(6) When the first battery 17 has entered the fully-charged state, i.e., when the output voltage of the first battery 17 has risen to an output voltage corresponding to the fully-charged state of the first battery 17 (timing t_{b} of FIG. 7), the charging of the first battery 17 is terminated.

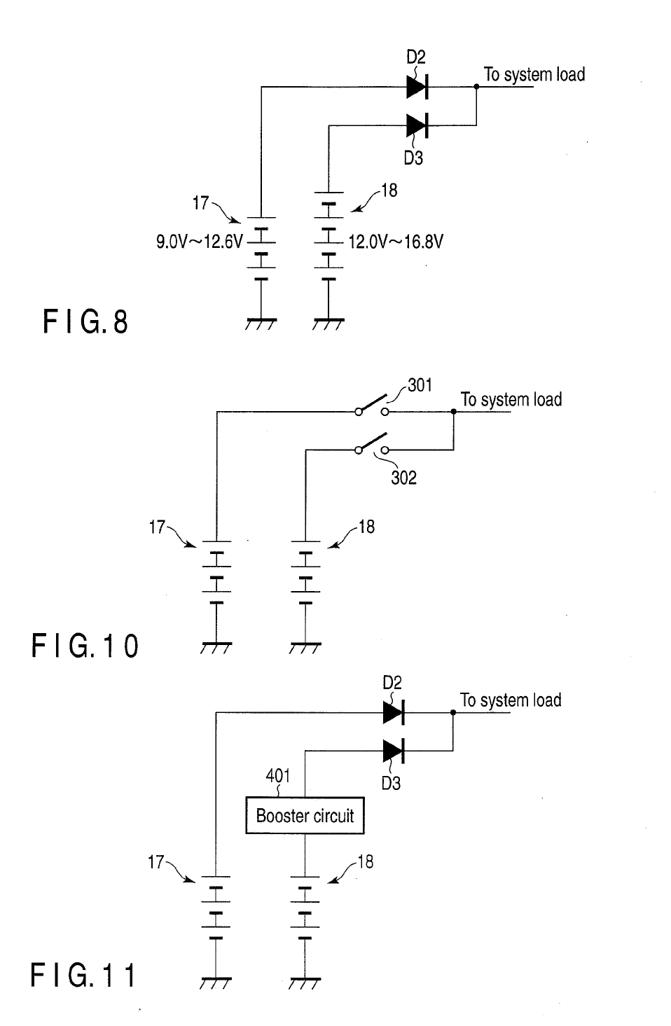

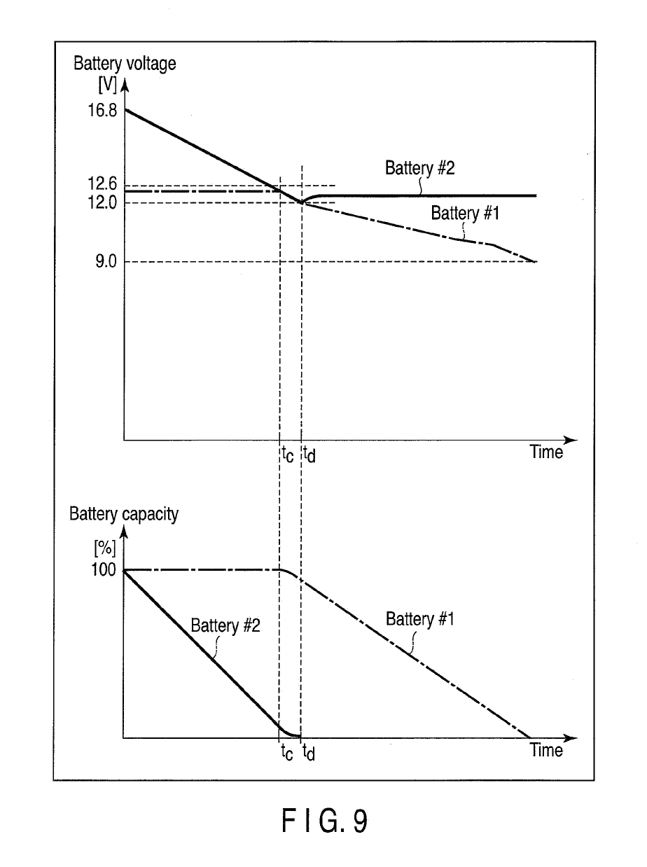

Next, a discharge control operation for each of the first battery 17 and second battery 18 will be described below with reference to FIG. 8 and FIG. 9.

FIG. 8 shows a discharge circuit section for the first battery 17 and second battery 18. As shown in FIG. 8, an output voltage range of the first battery 17, and output voltage range of the second battery 18 are different from each other.

The output voltage of the first battery 17 in the fully-charged state of the first battery 17 is a first voltage, and output voltage of the first battery 17 in the low-battery state of the first battery 17 is a second voltage lower than the first voltage. On the other hand, the output voltage of the second battery 18 in the fully-charged state of the second battery 18 is a third voltage higher than the first voltage, and output voltage of the second battery in the low-battery state of the second battery 18 is a fourth voltage lower than the first voltage, and higher than the second voltage.

More specifically, the output voltage range of each battery is set, for example, as follows.

Although the rated output voltage of the first battery 17 is, for example, 10.8 [V] as described in FIG. 2, actually, the output voltage of the first battery 17 changes in accordance with the residual capacity of the first battery 17. The first battery 17 is designed in such a manner that, for example, the output voltage thereof changes within a first voltage range of, for example, 9.0 [V] to 12.6 [V]. When the first battery 17 is in the fully-charged state, the output voltage of the first battery 17 is, for example, 12.6 [V] or a value in the vicinity thereof. When the first battery 17 is in the low-battery state where the residual capacity of the first battery is less than the threshold, the output voltage of the first battery 17 becomes, for example, 9.0 [V].

Although the rated output voltage of the second battery 18 is, for example, 14.4 [V] as described in FIG. 2, actually, the output voltage of the second battery 18 also changes in accordance with the residual capacity of the second battery 18. The second battery 18 is designed in such a manner that the output voltage thereof changes within a second voltage range of, for example, 12.0 [V] to 16.8 [V]. When the second battery 18 is in the fully-charged state, the output voltage of the second battery 18 is, for example, 16.8 [V] or a value in the vicinity thereof. When the second battery 18 is in the low-battery state where the residual capacity of the second battery is less than the threshold, the output voltage of the second battery 18 becomes, for example, 12.0 [V].

The lower end area of the output voltage range (second voltage range: 12.0 [V] to 16.8 [V]) of the second battery 18 overlaps the upper end area of the output voltage range (first voltage range: 9.0 [V] to 12.0 [V]) of the first battery 17. As a result of this, it is possible to switch the power source from the second battery 18 to the first battery 17 before the residual capacity of the second battery 18 becomes zero. Furthermore, when the power source is switched from the second battery 18 to the first battery 17, it is possible to discharge power from both the second battery 18 and first battery 17. Accordingly, at the time of the power source switching, it is possible to supply stable power to the system load without bringing about problems such as variation in the power-supply voltage, and the like.

The graph on the upper side of FIG. 9 shows the state of a change in the battery voltage in the discharging period. The axis of ordinate of the graph indicates the output voltage (battery voltage) of each of the first battery 17 and second battery 18, and axis of abscissa thereof indicates time.

On the other hand, the graph on the lower side of FIG. 9 shows the state of a change in the battery capacity in the discharging period. The axis of ordinate of the graph indicates the capacity (residual capacity) of each of the first battery 17 and second battery 18, and axis of abscissa thereof indicates time.

As described above, the first battery 17 and second battery 18 are connected to the power output terminal OUT by the diode-OR connection, and the output voltage of the second battery 18 is higher than the output voltage of the first battery 17. Accordingly, during a period in which the AC adapter 122 is not connected to the computer 10, the second battery 18 is discharged more preferentially than the first battery 17.

At the time (timing t_{c}) at which a predetermined period has elapsed from the start of the discharge of the second battery 18, and the residual capacity of the second battery 18 has lowered to a value in the vicinity of the low-battery state, the output voltage of the second battery 18 lowers to a value lower than the threshold, and becomes a value identical with the output voltage of the first battery 17. During a period from the timing t_{c} to the timing t_{d}, currents are discharged from the first battery 17 and second battery 18. After the timing t_{d}, a current is discharged only from the first battery 17. It should be noted that after the timing t_{d}, the over-discharge prevention protector, i.e., the discharge cutoff detector 184 operates to cut off the discharge path of the second battery 18, and hence the output voltage of the second battery 18 rises.

In the description given so far, the configuration in which the first battery 17 and second battery 18 are connected to the power output terminal OUT by the diode-OR connection, and output voltage of the second battery 18 is set higher than the output voltage of the first battery 17 has been described. However, the configuration used for discharging the second battery 18 more preferentially than the first battery is not limited to this.

For example, as shown in FIG. 10, switches 301 and 302 may be inserted in the discharge paths of the first battery 17 and second battery 18.

During the period in which each of the first battery 17 and second battery 18 is in the dischargeable state, the power-supply controller 120 sets the switch 302 in the on-state, and sets the switch 301 in the off-state. As a result of this, the second battery can be preferentially discharged. When the residual capacity of the second battery has become small, the power-supply controller 120 controls the switches 301 and 302 to switch the power source from the second battery 18 to the first battery 17. In this case, for example, both the switches 301 and 302 may be set in the on-state for a predetermined period, and thereafter only the switch 302 may be turned off.

Further, as shown in FIG. 11, a booster circuit 401 configured to boost the output voltage of a battery may be connected to the power-supply terminal of the second battery 18, and the power-supply terminal of the first battery 17, and an output terminal of the booster circuit 401 may be connected to the power output terminal OUT of the power-supply circuit 121 by the diode-OR connection. In this configuration, the output voltages of the two batteries may be identical with each other, and hence the configuration is not restricted by the number of series-connected battery cells.

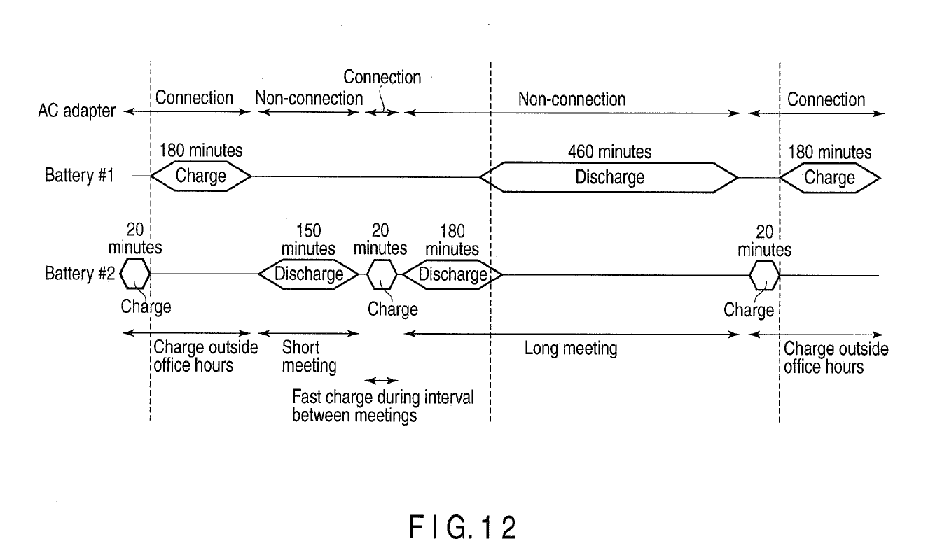

Next, an example of a relationship between an example of use of the computer 10, and charge/discharge operations of the two batteries will be described below with reference to FIG. 12.

As described previously, in this embodiment, the second battery 18 having the feature of being capable of fast charge, and of a long life is charged/discharged more preferentially than the first battery 17 which is a high-capacity battery. Accordingly, as a result of this, it is possible to realize the following usage pattern of the computer 10 in an office, factory or the like.

(1) Charging of the first battery 17 of high-capacity takes much time, and hence the charging of the first battery 17 is carried out at and after the quitting time.

(2) The second battery 18 capable of fast charge, and having a long life is charged during a relatively short period such as an interval between meetings.

(3) The two batteries are continuously used during a long meeting or at the time of going out. For example, first, the computer 10 is driven by the second battery 18, and after the second battery 18 enters the low-battery state, the computer 10 is driven by the first battery 17. By the procedure described above, the long-time battery drive of the computer 10 is realized.

In FIG. 12, a case where a short meeting and long meeting are set in the working hours from the start of working hours to the quitting time with a short interval between the meetings is assumed. During each meeting, the user uses the computer 10 in the meeting room. For this reason, during the time frame of each meeting, the AC adapter 122 is not connected to the computer 10. During the time frame of the interval between the two meetings, the user can use the computer 10 at the user's seat. Accordingly, during the time frame of the interval between the two meetings, it is possible to connect the AC adapter 122 to the computer 10. During the time frame after the quitting time too, the AC adapter 122 is connected to the computer 10.

Here, it is assumed that both of the two batteries 17 and 18 are in the dischargeable state (not in the low-battery state). During the first short meeting (for example, a 150-minute meeting), the computer 10 is driven by the power discharged from the second battery 18. During the time frame (for example, about 20 minutes) of the interval between the first short meeting and next long meeting (for example, a 640-minute meeting), the second battery 18 is subjected to fast charge by the power from the AC adapter 122. During the long meeting too, at first, the computer 10 is driven by the power discharged from the second battery 18. This is because the residual capacity of the second battery 18 is increased by the charging already carried out, and the second battery 18 is in the dischargeable state.

Further, when the residual capacity of the second battery 18 lowers to a threshold corresponding to the low-battery state (for example, the point at which 180 minutes elapses from the start of the long meeting), the power source is automatically switched from the second battery 18 to the first battery 17. From this point forward until the long meeting ends, the computer 10 is driven by the power discharged from the first battery 17.

When the long meeting ends, the AC adapter 122 is connected to the computer 10. Both the batteries 17 and 18 are in a state close to the low-battery state. In preparation for the next battery drive, first, charging of the second battery 18 is started. When the second battery 18 is fully charged, the battery to be charged is automatically switched from the second battery 18 to the first battery 17, and charging of the first battery 17 is started.

As described above, in this embodiment, during a period in which the power source of the computer 10 is switched between the battery (battery 17 or 18) and AC adapter at relatively short intervals, only the second battery 18 is charged/discharged, and first battery 17 is not charged/discharged. When battery drive of a long period such as a long meeting or the time of going out is required, both the second battery 18 and first battery 17 are discharged in the order mentioned. Accordingly, it becomes possible to reduce the charge/discharge frequency of the first battery 17 to a frequency lower than the charge/discharge frequency of the second battery 18.

Now, assuming that short charge and discharge (that is, charge and discharge of the second battery 18) is carried out two times a day, and long charge and discharge (that is, charge and discharge of the second battery 18 and charge and discharge of the first battery 17) is carried out two times a week, and further assuming that charge and discharge of one time corresponds to one charge-discharge cycle, the life of each of the second battery 18 and first battery 17 is expressed as follows.

Battery 18: 40 charge-discharge cycles/month→from FIG. 2, the life of the battery 18 is about 4 years

Battery 17: 8 charge-discharge cycles/month→from FIG. 2, the life of the battery 17 is about 5 years

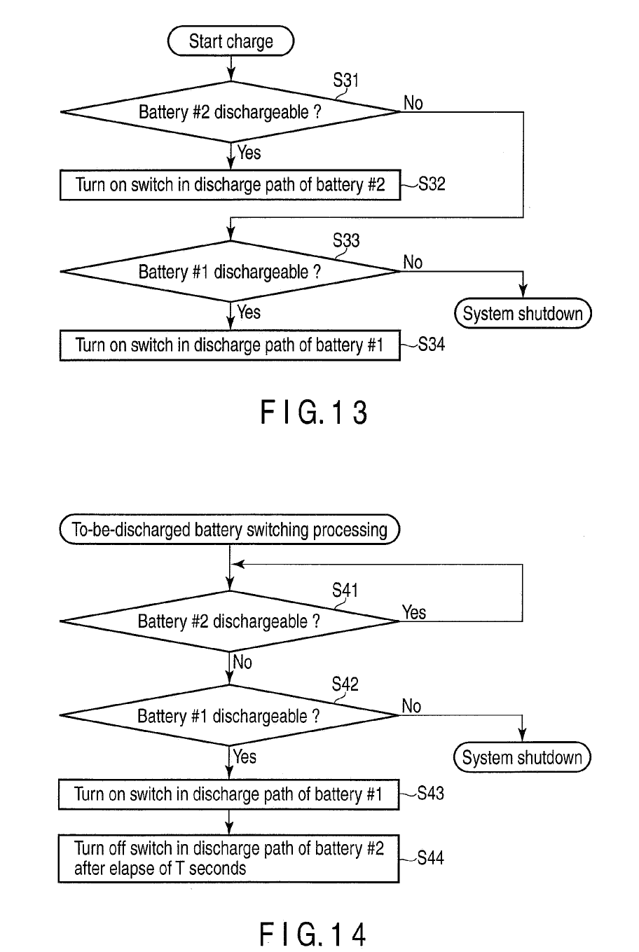

Next, the procedure of discharge control processing to be applied to the discharge circuit of FIG. 10 will be described below with reference to FIG. 13.

When the discharge from the battery 17 or 18 becomes necessary, the power-supply controller 120 first determines whether or not the second battery 18 is in the dischargeable state (step S31). For example, when the output voltage of the second battery 18 is higher than a predetermined value, that is, when the second battery 18 is not in the low-battery state, it is determined that the second battery 18 is in the dischargeable state. When the second battery 18 is in the dischargeable state (YES in step S31), in order to supply power to the components in the computer 10, the power-supply controller 120 turns on the switch 302 in the discharge path of the second battery 18 to discharge the second battery 18 (step S32).

When the second battery 18 is not in the dischargeable state (NO in step S31), the power-supply controller 120 determines whether or not the first battery 17 is in the dischargeable state (step S33). For example, when the output voltage of the first battery 17 is higher than a predetermined value, that is, when the first battery 17 is not in the low-battery state, it is determined that the first battery 17 is in the dischargeable state. When the first battery 17 is in the dischargeable state (YES in step S33), in order to supply power to the components in the computer 10, the power-supply controller 120 turns on the switch 301 in the discharge path of the first battery 17 to discharge the first battery 17 (step S34).

Next, the procedure of to-be-discharged battery switching processing to be applied to the discharge circuit of FIG. 10 will be described below with reference to FIG. 14.

Now, it is assumed that the second battery 18 is being discharged, that is, the second battery 18 is being used as the power source. The power-supply controller 120 determines whether or not the second battery 18 is in the dischargeable state (step S41). When the output voltage of the second battery 18 lowers to the threshold due to lowering of the residual capacity of the second battery 18, it is determined by the power-supply controller 120 that the second battery 18 is not in the dischargeable state. When it is determined that the second battery 18 is not in the dischargeable state (NO in step S41), the power-supply controller 120 determines whether or not the first battery 17 is in the dischargeable state (step S42). When the first battery 17 is in the dischargeable state (YES in step S42), the power-supply controller 120 first turns on the switch 301 in the discharge path of the first battery 17 to start discharging the first battery 17 (step S43). Further, after an elapse of a predetermined time (T seconds) from the turning on of the switch 301, the power-supply controller 120 turns off the switch 302 in the discharge path of the second battery 18 (step S44).

As described above, according to this embodiment, a hybrid battery system including the first battery 17 and second battery 18 the charge-discharge cycle life of which is longer than the first battery 17 is realized. The second battery 18 is charged/discharged more preferentially than the first battery 17. As a result of this, it becomes possible to reduce the frequency of charging/discharging the first battery 17, and hence it is possible to delay the deterioration in performance of the first battery 17. On the other hand, the charge-discharge cycle life of the second battery 18 is long, and hence even if the frequency in which the second battery 18 is charged/discharged is high, the degree of deterioration of the second battery 18 is very small. Accordingly, it is possible to prolong the battery life without sacrificing the battery drive time.

It should be noted that in this embodiment, although the case where a battery simultaneously having two characteristics of being capable of fast charge, and having a long charge-discharge cycle life is used as the second battery 18 has been exemplified, the second battery 18 does not necessarily have to have the characteristic of being capable of fast charge.

Further, in this embodiment, although the case where the capacity of the first battery 17 is greater than the capacity of the second battery 18 has been assumed, each of the capacity of the first battery 17, and capacity of the second battery 18 may also be set at an arbitrary value.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first power-supply terminal configured to receive power from a first battery, the first battery comprising a first charge-discharge cycle life;
a second power-supply terminal configured to receive power from a second battery, the second battery comprising a second charge-discharge cycle life, wherein the second charge-discharge cycle life is longer than the first charge-discharge cycle life;
a power-supply circuit configured to discharge the second battery more preferentially than the first battery in order to supply power to components in the information processing apparatus; and
a charging module configured to charge the second battery more preferentially than the first battery.

2. The information processing apparatus of claim 1, wherein
an output voltage of the second battery is higher than an output voltage of the first battery, and
the power-supply circuit comprises a power output terminal, a first diode connected between the first power-supply terminal of the first battery and the power output terminal, and a second diode connected between the second power-supply terminal of the second battery and the power output terminal.

3. The information processing apparatus of claim 1, wherein the power-supply circuit is configured to switch a battery to be discharged from the second battery to the first battery when the residual capacity of the second battery lowers to a value lower than a threshold.

4. The information processing apparatus of claim 1, wherein the second battery has a higher fast-charge capability than the first battery.

5. The information processing apparatus of claim 1, wherein the capacity of the first battery is greater than the capacity of the second battery.

6. The information processing apparatus of claim 1, wherein:
the first battery comprises a first voltage, the first voltage comprising the output voltage of the first battery in the fully-charged state of the first battery;
the first battery comprises a second voltage, the second voltage comprising the output voltage of the first battery in a low-battery state of the first battery, wherein the second voltage is lower than the first voltage;
the second battery comprises a third voltage, the third voltage comprising the output voltage of the second battery in the fully-charged state of the second battery, wherein the third voltage is higher than the first voltage;
the second battery comprises a fourth voltage, the fourth voltage comprising the output voltage of the second battery in the low-battery state of the second battery, wherein the fourth voltage is lower than the first voltage, and wherein the fourth voltage is higher than the second voltage; and
the power-supply circuit comprises a power output terminal, a first diode connected between a power-supply terminal of the first battery and the power output terminal, and a second diode connected between a power-supply terminal of the second battery and the power output terminal.

7. A charge and discharge control method of controlling charge and discharge of a first battery and a second battery implemented on an electrical system, a charge-discharge cycle life of the second battery being longer than a charge-discharge cycle life of the first battery, the method comprising:
discharging the second battery more preferentially than the first battery, when the first battery and the second battery are in a dischargeable state; and
charging the second battery more preferentially than the first battery when the first battery and second battery are not in a fully-charged state.

8. The charge and discharge control method of claim 7, wherein discharging comprises switching a battery to be discharged from the second battery to the first battery when the residual capacity of the second battery lowers to a value lower than a threshold.

9. The charge and discharge control method of claim 7, wherein the second battery has a higher fast-charge capability than the first battery.

10. The charge and discharge control method of claim 7, wherein the capacity of the first battery is greater than the capacity of the second battery.

11. The charge and discharge control method of claim 7, wherein the method is performed on an information processing apparatus.

12. A battery power system comprising:
a first power-supply terminal configured to receive power from a first battery, the first battery comprising a first charge-discharge cycle life;
a second power-supply terminal configured to receive power from a second battery, the second battery comprising a second charge-discharge cycle life, wherein the second charge-discharge cycle life is longer than the first charge-discharge cycle life;
a power-supply circuit configured to discharge the second battery more preferentially than the first battery in order to supply power to components in an information processing apparatus; and
a charging module configured to charge the second battery more preferentially than the first battery.
